(19) United States
(12) Patent Application Publication
(10) Pub. No.: US 2016/0098203 A1
(43) Pub. Date: Apr. 7, 2016

(54) Heterogeneous Swap Space With Dynamic Thresholds

(71) Applicant: MediaTek Inc., Hsinchu (TW)

(72) Inventors: Chin-Wen Chang, Taichung (TW); Hung-Lin Chou, Zhubei (TW); Nicholas Ching Hui Tang, Hsinchu County (TW); Chih-Hsuan Tseng, Hsinchu (TW); Min-Hua Chen, Taichung (TW); Chung-Jung Lee, Taipei (TW)

(21) Appl. No.: 14/965,799

(22) Filed: Dec. 10, 2015

Related U.S. Application Data
(60) Provisional application No. 62/093,571, filed on Dec. 18, 2014.

(51) Int. Cl. G06F 3/06

(52) U.S. Cl. CPC G06F 3/064; G06F 3/0604; G06F 3/0673

(57) ABSTRACT

Techniques and implementations pertaining to a heterogeneous swap space with dynamic thresholds are provided. A technique may provide a list of a plurality of swap areas in a heterogeneous swap space. The swap areas may include at least two swap areas that are different from each other in one or more characteristics. The technique may also compute a dynamic threshold associated with a page in need of swapping and determine a priority level of the page in need of swapping based on the dynamic threshold. The technique may further select one of the swap areas from the list of swap areas for the swapping of the page in response to a determination of the priority level of the page.

### CROSS REFERENCE TO RELATED PATENT APPLICATION

The present disclosure claims the priority benefit of U.S. Provisional Patent Application No. 62/093,571, filed on 18 Dec. 2014, which is incorporated by reference in its entirety.

### TECHNICAL FIELD

The present disclosure is generally related to memory management and, more particularly, to a framework of heterogeneous swap space with dynamic threshold(s).

### BACKGROUND

Unless otherwise indicated herein, approaches described in this section are not prior art to the claims listed below and are not admitted to be prior art by inclusion in this section.

In computer operating systems (OS), paging is one of the memory management schemes by which a computer stores and retrieves data from one or more secondary storage mediums for use in a main memory. Under the memory management scheme of paging, the OS retrieves data from a secondary storage medium in same-size blocks also known as pages. Accordingly, paging allows an OS to use secondary storage mediums for storing data that does not fit into the main memory, which could be a type of random-access memory (RAM).

Swap subsystem is a feature of memory management scheme of paging. The purpose of a swap subsystem is to provide extended execution space for all system users with some execution overheads. Traditionally, there may be one or multiple swap areas with the same input/output (I/O) capability to provide more execution space. However, this type of swap subsystem tends to be less than optimal and not flexible for current complicated operating systems.

Presently there are various types of storage mediums for swap areas, but most existing frameworks of multiple swaps are typically composed of medium(s) with the same capability. Existing frameworks, however, tend to lack better adaptation to all variants of operating systems. Moreover, existing frameworks also tend to lack the capability of gathering information from performance-related indices for selection of swap areas.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

The present disclosure proposes a novel framework of heterogeneous swap areas for better adaptation to complicated operating systems. The term “heterogeneous” herein refers to a swap space may be composed of multiple swap areas with different characteristics such as, for example and not limited to, I/O speed, lifetime, and cost. The present disclosure also proposes a novel mechanism of dynamic threshold for the novel framework for choosing better swap areas. The dynamic threshold may be adjustable, for example, with respect to system status and process priority. That is, the proposed framework of heterogeneous swap space may be equipped with the capability of dynamic threshold for better performance.

In one example implementation, a method may involve providing a list of a plurality of swap areas in a heterogeneous swap space. The swap areas may include at least two swap areas that are different from each other in one or more characteristics. The method may also involve computing a dynamic threshold associated with a page in need of swapping (e.g., swap-out) and determining a priority level of the page in need of swapping based on the dynamic threshold. The method may further involve selecting one of the swap areas from the list of swap areas for the swapping of the page in response to a determination of the priority level of the page.

In yet another example implementation, an apparatus may include a heterogeneous swap space including a plurality of swap areas. The plurality of swap areas may include at least two swap areas that are different from each other in one or more characteristics. The apparatus may also include a processor configured to perform a number of operations. The processor may provide a list of the plurality of swap areas in the heterogeneous swap space. The processor may also compute a dynamic threshold associated with a page in need of swapping and determine a priority level of the page in need of swapping based on the dynamic threshold. The processor may further select one of the swap areas from the list of swap areas for the swapping of the page in response to a determination of the priority level of the page.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme in which various implementations in accordance with the present disclosure may be implemented.

FIG. 2 is a diagram of an example algorithm in accordance with an implementation of the present disclosure.

FIG. 3 is a diagram of an example algorithm in accordance with another implementation of the present disclosure.

FIG. 4 is a simplified block diagram of an example apparatus in accordance with an implementation of the present disclosure.

FIG. 5 is a flowchart of an example process in accordance with an implementation of the present disclosure.

### DETAILED DESCRIPTION OF PREFERRED EMBODIMENTS

### Overview

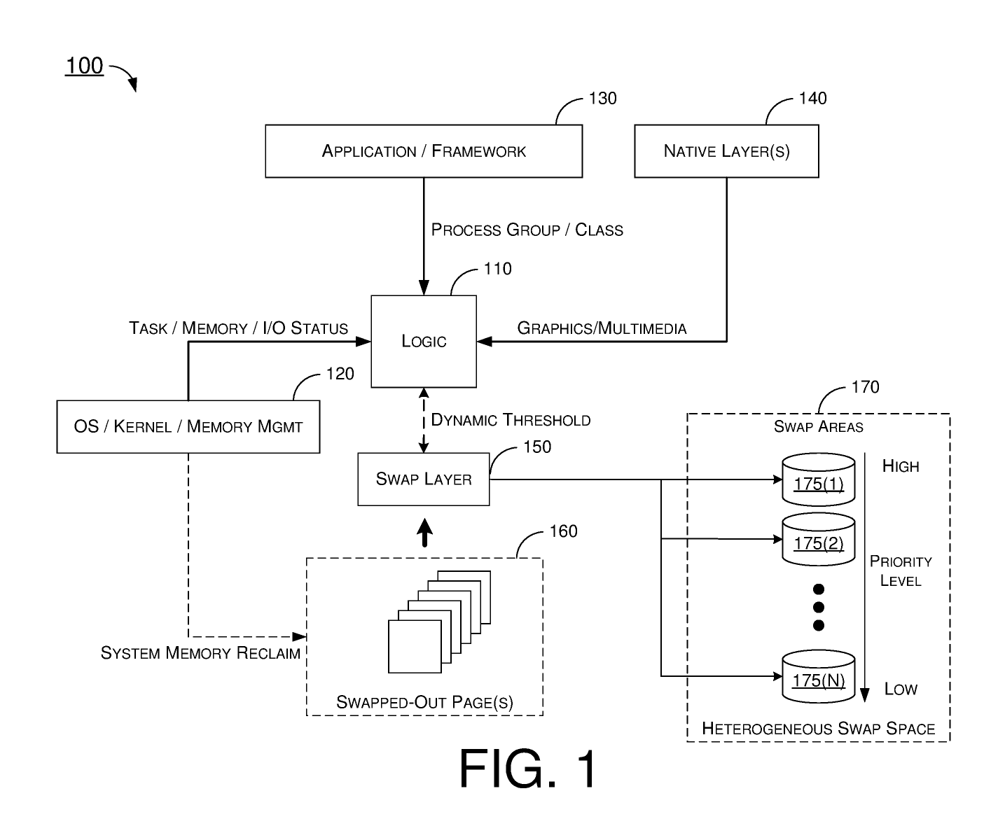

FIG. 1 illustrates an example scheme 100 in which various implementations in accordance with the present disclosure may be implemented. Scheme 100 may include a number of components, functions and operations pertaining to memory management under the scheme of paging for an OS in an electronic apparatus such as a computing apparatus, a portable apparatus or a wearable apparatus. Scheme 100 may include a heterogeneous swap space for better adaptation to today's ever-complicated OS. By “heterogeneous” it is referred to a swap space that is composed of multiple swap areas with one or more different characteristics such as, for example and not limited to, input/output (I/O) speed, lifetime and cost/price. The multiple swap areas may be established on one or more memory/storages (herein interchangeably referred to as “mediums”). Scheme 100 may also include a technique or mechanism of dynamic threshold for better swap area selection. That is, dynamic threshold in accordance with the present disclosure may be adjustable, for example, with respect to system status and process priority to provide better performance.

Referring to FIG. 1, scheme 100 may include a logic 110 and a heterogeneous swap space 170. The logic 110 may be implemented in the form of hardware, software, middleware or firmware, or any combination thereof. Heterogeneous swap space 170 may include multiple swap areas 175(1)-175(N) where N is a positive integer greater than 1. The swap areas 175(1)-175(N) may be created or otherwise established, for example by logic 110, on one or more memory/storages (herein interchangeably referred to as “mediums”). The swap areas 175(1)-175(N) may differ from one another in one or more characteristics such as, for example, I/O speed, lifetime and cost/price. In one scenario, at least two of swap areas 175(1)-175(N) may be created or established on different mediums with different I/O speeds. For instance, one of swap areas 175(1)-175(N) may be established on a dynamic random-access memory (DRAM) while another one of swap areas 175(1)-175(N) may be established on a solid-state drive (SSD) or disk, and the DRAM and the SSD (or disk) have different I/O speeds. For illustrative purpose without limiting the scope of the present disclosure, Table 1 below shows an example of this scenario. I/O speed may also refer to throughput.

TABLE 1

| | | Throughput | | Compression | |
|---|---|---|---|---|---|
| | | (MB/s) | | Ratio | |
| | | Compress/ | Decompress/ | OrigSize/ | OrigSize/ |
| | | Write | Read | ComprSize | MemUsed |
| Swap | Algo- | 144.9 | 337.5 | 3.35 | 2.63 |
| in | rithm 1 | 95.1 | 173.2 | 4.2 | 3.2 |
| volatile | Algo- | | | | |
| medium | rithm 2 | | | | |

| | | | | |
|---|---|---|---|---|
| Swap in non- | 29 | 162 | N/A | N/A |
| volatile medium | | | | |

Alternatively or additionally, two or more of swap areas 175(1)-175(N) may be created or established on the same medium, and such two or more swap areas on the same medium may be equipped or associated with compression algorithms of different performances. For instance, two of swap areas 175(1)-175(N) may be created with different compression algorithms such as, for example, LZO and LZ4HC. For illustrative purpose without limiting the scope of the present disclosure, Table 2 below shows an example of this scenario. The same medium equipped or associated with different compression algorithms may have different I/O speeds. For Example, higher compression speed and/or higher decompression speed may be associated with higher I/O speed.

TABLE 2

| Compression | | | |
|---|---|---|---|
| Algorithm | Ratio | C.speed (MB/s) | D.speed (MB/s) |
| LZ4 (r101) | 2.084 | 422 | 1820 |
| LZO 2.06 | 2.106 | 414 | 600 |
| zlib 1.2.8-1 | 2.730 | 65 | 280 |
| zlib 1.2.8-6 | 3.099 | 21 | 300 |

A prioritized list of swap areas 175(1)-175(N) may be constructed by prioritizing swap areas 175(1)-175(N) according to at least one of the one or more characteristics. The prioritized list may be constructed by logic 110. As an illustrative example without limiting the scope of the present disclosure, the swap areas 175(1)-175(N) may be prioritized according to the I/O speed of the swap areas 175(1)-175(N). In the scenario that the swap areas 175(1)-175(N) are established on different mediums, the swap areas 175(1)-175(N) may be prioritized according to the I/O speed of the respective medium on which each of swap areas 175(1)-175(N) is established. In the scenario that the swap areas 175(1)-175(N) are established on the same medium, the swap areas 175(1)-175(N) may be prioritized according to the I/O speed of the swap areas, which may be associated with the respective compression algorithm that each of swap areas 175(1)-175(N) is equipped with. As an illustrative example without limiting the scope of the present disclosure, the prioritized list of swap areas 175(1)-175(N) may be in a descending order of priority in that those of swap areas 175(1)-175(N) associated with the highest/higher I/O speed(s) may be placed at the highest/higher priority position(s) on the list, and those of swap areas 175(1)-175(N) associated with the lowest/lower I/O speed(s) may be placed at the lowest/lower priority position(s) on the list. Logic 110 may revisit and revise, as necessary, this prioritized list repeatedly.

Scheme 100 may also include a function 120 of operating system, kernel and/or memory management, a function 130 of application/framework, one or more native layers 140, and a swap layer 150. In scheme 100, functions 130 and 140 may be in a user space, and logic 110, function 120, swap layer 150 and heterogeneous swap space 170 may be in a kernel space. Logic 110 may function as an information gathering center for computing or otherwise determining a dynamic threshold by gathering indices of status and information from function 120, function 130 and native layer(s) 140. For instance, logic 110 may gather one or more indices related to a page in need of swapping (e.g., to be swapped out), and such indices may include, for example and not limited to, process groups according to the priority definition in the user space, a size of cache and/or free memory in the kernel space, I/O congestion status related to the swap areas, a process class of the process requiring page swap (e.g., whether it is real time), and a size of hardware-used memory (e.g., the status of memory usage associated with graphics-processing unit (GPU) and/or multimedia processing unit). For illustrative purpose without limiting the scope of the present disclosure, Table 3 below shows an example of a dynamic threshold table.

TABLE 3

| | Status | Priority |
|---|---|---|
| Cache/free memory | More | Higher |
| status | | |
| I/O status | Higher | Lower |
| Process group/priority | Higher | Higher |
| Process class | Real-time | Higher |
| Hardware memory status | More | Lower |

The function 120 of OS, kernel and/or memory management may indicate, provide or otherwise make available one or more swapped-out pages 160 for system memory reclamation, for example, through swap layer 150. Swap layer 150 may receive the dynamic threshold from logic 110 to select one of swap areas 175(1)-175(N) for the page in need of swapping. Logic 110 may determine the selection flow of swap areas 175(1)-175(N). For instance, logic 110 may determine a priority level (e.g., high or low) of the page in need of swapping based on the dynamic threshold. In one scenario, corresponding to algorithm 200 described below, logic 110 may select one of swap areas 175(1)-175(N) with higher I/O speed, if available, to be the swap area for the page in an event that logic 110 determines the priority level of the page as high priority. In another scenario, corresponding to algorithm 300 described below, logic 110 may select the swap area(s) with the highest I/O speed(s) first regardless of the priority level of the page in need of swapping, so long as certain threshold condition(s) is/are met, before such swap area(s) with the highest I/O speed(s) is/are exhausted (not available).

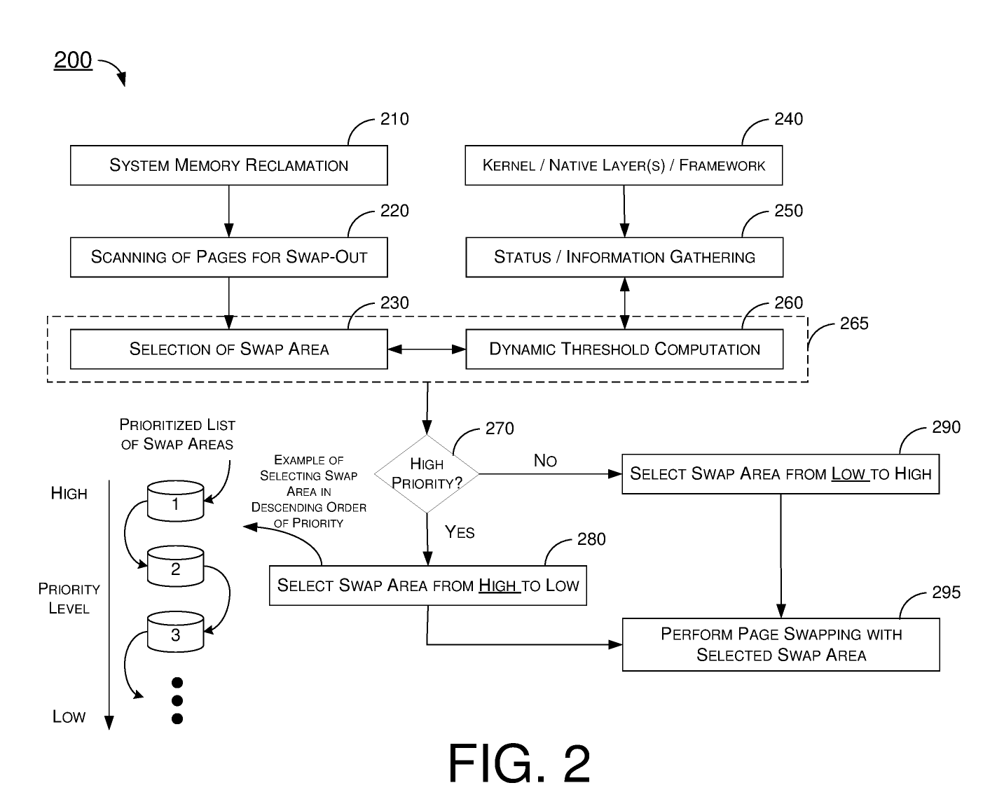

FIG. 2 illustrates an example algorithm 200 in accordance with an implementation of the present disclosure. Algorithm 200 may include one or more operations, actions, or functions as represented by one or more of blocks 210, 220, 230, 240, 250, 260, 265, 270, 280, 290 and 295. Although illustrated as discrete blocks, various blocks of algorithm 200 may be divided into additional blocks, combined into fewer blocks, or eliminated, depending on the desired implementation. The blocks may be performed in the order shown in FIG. 2 or in any other order, depending on the desired implementation. Algorithm 200 may be implemented in scheme 100. Algorithm may begin at 210 and/or 240.

At 210, algorithm 200 may involve system memory reclamation, which may be performed, triggered or otherwise initiated by an OS, kernel or memory management mechanism such as, for example, function 120 of OS, kernel and/or memory management in scheme 100. Algorithm 200 may proceed from 210 to 220.

At 220, algorithm 200 may involve scanning of pages for swap-out, which may be performed by swap layer 150 in scheme 100. Algorithm 200 may proceed from 220 to 230.

At 230, algorithm 200 may involve triggering or otherwise initiating the selection of a swap area for each page in need of swapping (e.g., needing to be swapped out), which may be performed by swap layer 150 in scheme 100.

At 240, algorithm 200 may involve a kernel, native layer(s) and/or framework operating under the memory management scheme of paging. Algorithm 200 may proceed from 240 to 250.

At 250, algorithm 200 may involve gathering of one or more indices of status and information of each page that needs to be swapped out. For instance, the one or more indices may be gathered from the kernel, native layer(s) and/or framework. The one or more gathered indices may include process groups according to the priority definition in the user space, a size of cache and/or free memory in the kernel space, I/O congestion status related to the swap areas, a process class of the process requiring page swap (e.g., whether it is real time), and a size of hardware-used memory (e.g., the status of memory usage associated with GPU and/or multimedia processing unit). Algorithm 200 may proceed from 250 to 260.

At 260, algorithm 200 may involve computation of a dynamic threshold for a page in need of swapping.

At 265, algorithm 200 may involve assigning a priority level (e.g., high or low) to the page in need of swapping based on the dynamic threshold. Algorithm 200 may proceed from 265 to 270.

At 270, algorithm 200 may involve determination of whether the priority level of the page in need of swapping is high priority or low priority. In an event that the priority level of the page is determined to be high level, algorithm 200 may proceed from 270 to 280. Otherwise, in an event that the priority level of the page is determined to be low level, algorithm 200 may proceed from 270 to 290.

At 280, algorithm 200 may involve selecting a swap area from the prioritized list of swap areas in a descending order of priority from high priority to low priority. That is, selecting swap area(s) of high priority level first, until all high-priority swap areas are exhausted, before selecting swap area(s) of low priority level. Algorithm 200 may proceed from 280 to 295.

At 290, algorithm 200 may involve selecting a swap area from the prioritized list of swap areas in an ascending order of priority from low priority to high priority. That is, selecting swap area(s) of low priority level first, until all low-priority swap areas are exhausted, before selecting swap area(s) of high priority level. Algorithm 200 may proceed from 290 to 295.

At 295, algorithm 200 may involve performing page swapping with the selected swap area. For instance, algorithm 200 may swap out the page in need of swapping using the selected swap area.

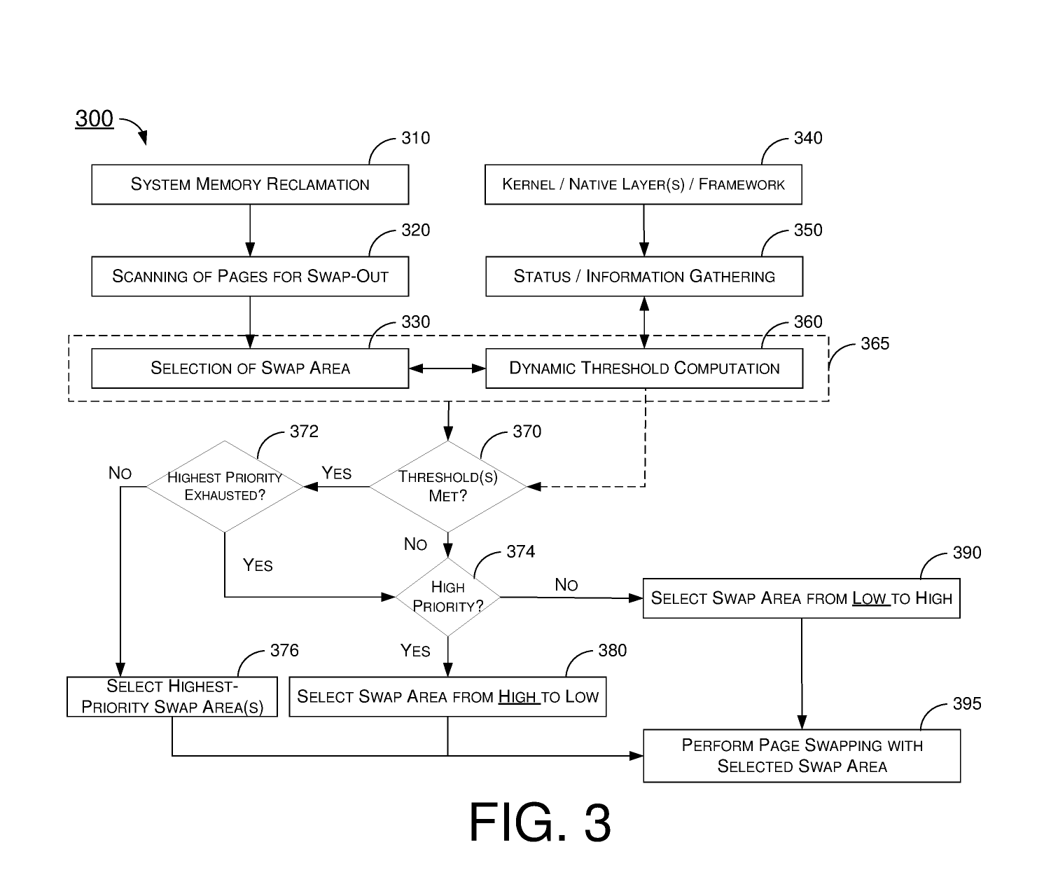

FIG. 3 illustrates an example algorithm 300 in accordance with another implementation of the present disclosure. Algorithm 300 may be a variation of algorithm 200. Algorithm 300 may include one or more operations, actions, or functions as represented by one or more of blocks 310, 320, 330, 340, 350, 360, 365, 370, 372, 374, 376, 380, 390 and 395. Although illustrated as discrete blocks, various blocks of algorithm 300 may be divided into additional blocks, combined into fewer blocks, or eliminated, depending on the desired implementation. The blocks may be performed in the order shown in FIG. 3 or in any other order, depending on the desired implementation. Algorithm 300 may be implemented in scheme 100. Algorithm may begin at 310 and/or 340.

At 310, algorithm 300 may involve system memory reclamation, which may be performed, triggered or otherwise initiated by an OS, kernel or memory management mechanism such as, for example, function 120 of OS, kernel and/or memory management in scheme 100. Algorithm 300 may proceed from 310 to 320.

At 320, algorithm 300 may involve scanning of pages for swap-out, which may be performed by swap layer 150 in scheme 100. Algorithm 300 may proceed from 320 to 330.

At 330, algorithm 300 may involve triggering or otherwise initiating the selection of a swap area for each page in need of swapping (e.g., needing to be swapped out), which may be performed by swap layer 150 in scheme 100.

At 340, algorithm 300 may involve a kernel, native layer(s) and/or framework operating under the memory management scheme of paging. Algorithm 300 may proceed from 340 to 350.

At 350, algorithm 300 may involve gathering of one or more indices of status and information of each page that needs to be swapped out. For instance, the one or more indices may be gathered from the kernel, native layer(s) and/or framework. The one or more gathered indices may include process groups according to the priority definition in the user space, a size of cache and/or free memory in the kernel space, I/O congestion status related to the swap areas, a process class of the process requiring page swap (e.g., whether it is real time), and a size of hardware-used memory (e.g., the status of memory usage associated with GPU and/or multimedia processing unit). Algorithm 300 may proceed from 350 to 360.

At 360, algorithm 300 may involve computation of a dynamic threshold for a page in need of swapping.

At 365, algorithm 300 may involve assigning a priority level (e.g., high or low) to the page in need of swapping based on the dynamic threshold. Algorithm 300 may proceed from 365 to 370.

At 370, algorithm 300 may involve determination of whether one or more threshold conditions is/are met. The one or more threshold conditions may include, for example and not limited to, whether the amount of available cache and/or free memory is higher than a predetermined level, whether process group or process priority is higher than another predetermined level, or a combination of the above conditions. In an event of a determination that the one or more threshold conditions is/are met, algorithm 300 may proceed from 370 to 372. Otherwise, in an event of a determination that none of the one or more threshold conditions is met, algorithm 300 may proceed from 370 to 374.

At 372, algorithm 300 may involve determination of the availability of one or more swap areas having a highest priority level in the prioritized list of swap areas. In an event of a determination that the one or more swap areas having the highest priority level is/are not available (e.g., exhausted), algorithm 300 may proceed from 372 to 374. Otherwise, in an event of a determination that the one or more swap areas having the highest priority level is/are available (e.g., not exhausted), algorithm 300 may proceed from 372 to 376.

At 374, algorithm 300 may involve determination of whether the priority level of the page in need of swapping is high priority or low priority. In an event that the priority level of the page is determined to be high level, algorithm 300 may proceed from 374 to 380. Otherwise, in an event that the priority level of the page is determined to be low level, algorithm 300 may proceed from 374 to 390.

At 376, algorithm 300 may involve selecting, among available high-priority swap areas, the swap area with the highest priority level. Algorithm 300 may proceed from 376 to 395.

At 380, algorithm 300 may involve selecting a swap area from the prioritized list of swap areas in a descending order of priority from high priority to low priority. That is, selecting swap area(s) of high priority level first, until all high-priority swap areas are exhausted, before selecting swap area(s) of low priority level. Algorithm 300 may proceed from 380 to 395.

At 390, algorithm 300 may involve selecting a swap area from the prioritized list of swap areas in an ascending order of priority from low priority to high priority. That is, selecting swap area(s) of low priority level first, until all low-priority swap areas are exhausted, before selecting swap area(s) of high priority level. Algorithm 300 may proceed from 390 to 395.

At 395, algorithm 300 may involve performing page swapping with the selected swap area. For instance, algorithm 300 may swap out the page in need of swapping using the selected swap area.

### Example Implementations

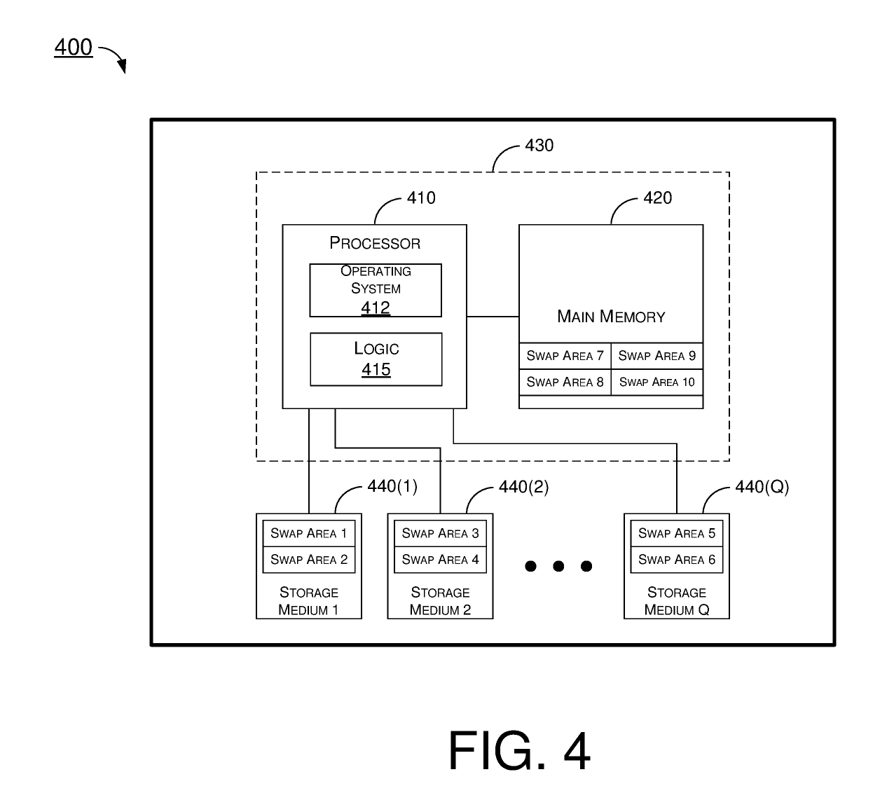

FIG. 4 illustrates an example apparatus 400 in accordance with an implementation of the present disclosure. In some implementations, apparatus 400 may be an electronic apparatus. For instance, apparatus 400 may be a computing apparatus, a portable apparatus or a wearable apparatus. In some implementations, apparatus 400 may be a smartphone, a tablet computer, a laptop computer, a notebook computer, a desktop computer, a wearable computing apparatus, a wearable communication apparatus or the like. In some implementations, apparatus 400 may be a single integrated-circuit (IC) chip, a chip set or multiple discrete and separate IC chips. Regardless of the form in which apparatus 400 is implemented, apparatus 400 may be configured to implement scheme 100, algorithm 200 and algorithm 300 described above.

Apparatus 400 may include various components including those shown in FIG. 4. To avoid obscuring the figure and to focus on components and features pertinent to the present disclosure, components of apparatus 400 relevant to implementations of the present disclosure are shown in FIG. 4 while other components of apparatus 400 are not shown. Referring to FIG. 4, apparatus 400 may include an example platform 430 which may include a processor 410 and a main memory 420 communicatively coupled to each other. Platform 430 may be implemented as a single IC chip, a chip set or multiple discrete and separate IC chips. Main memory 420 may be a type of random-access memory (RAM) such as, for example and not limited to, DRAM, static random-access memory (SRAM), zero-capacitor random-access memory (Z-RAM), thyristor random-access memory (T-RAM), magnetoresistive random-access memory (MRAM) and non-volatile random-access memory (NVRAM). Apparatus 400 may also include multiple secondary storage mediums such as, for example, mediums 440(1)-440(Q) where Q is a positive integer greater than or equal to 1. Each of the multiple mediums 440(1)-440(0) may be, for example, a type of RAM (e.g., DRAM), flash, embedded multimedia card (eMMC), secure digital (SD) memory card, SSD or disk. These multiple mediums may have different I/O speeds. For instance, at least two of the multiple mediums 440(1)-440(Q) may have different I/O speeds.

Processor 410 may access data stored in main memory 420 by writing, reading, deleting and modifying data stored therein. Processor 410 may also execute an operating system 412 therein. Operating system 412 may utilize the memory management scheme of paging and retrieve data not only from main memory 420 but also from the multiple mediums 440(1)-440(Q) in same-size pages.

Apparatus 400 may include a heterogeneous swap space for memory management under the paging scheme. The heterogeneous swap space may include multiple swap areas such as, for example, swap area 1, swap area 2, swap area 3, swap area 4, swap area 5, swap area 6, swap area 7, swap area 8, swap area 9 and swap area 10, as shown in FIG. 4. In some implementations, at least two of the swap areas 1-10 may be established on different mediums with different I/O speeds. For instance, in the example shown in FIG. 4, swap area 1 may be established on medium 440(1) and swap area 3 may be established on medium 440(2), and I/O speeds of medium 440(1) and medium 440(2) may be different. In some implementations, at least some of the multiple swap areas may be established on the same medium. For instance, in the example shown in FIG. 10, swap area 1 and swap area 2 may be established on medium 440(1), swap area 3 and swap area 4 may be established on medium 440(2), swap area 5 and swap area 6 may be established on medium 440(0), and swap areas 7-10 may be established on main memory 420. In some implementations, different compression algorithms may be associated with swap areas established on the same medium. For instance, swap area 1 may be associated with a first compression algorithm and swap area 2 may be associated with a second compression algorithm which is different from the first compression algorithm, and likewise for other swap areas that are established on the same medium. The swap areas established on the same medium equipped or associated with different compression algorithms may have different I/O speeds. For example, higher compression speed and/or higher decompression speed may be associated with higher I/O speed. As an example not limiting the scope of the present disclosure, medium 440(1) may be a Z-RAM as a module for Linux to construct in-RAM disk with compression. In this example, swap area 1 may be associated with compression algorithm LZO and swap area 2 may be associated with compression algorithm LZ4HC. Other suitable compression algorithms may also be utilized in various implementations of the present disclosure, such as, for example and not limited to, LZ4, LZF, LZ77, Snappy or any variations thereof.

Processor 410 may also include a logic 415 which may be implemented in the form of hardware, software, middleware or firmware, or any combination thereof. That is, logic 415 may be implemented in or executed by processor 410. Logic 415 may be an example implementation of logic 110, or a combination of logic 110 and swap layer 150, of scheme 100, and may be configured to implement techniques described above with respect to logic 110. For instance, logic 415 may generate a list of the multiple swap areas (e.g., swap areas 1-10) in the heterogeneous swap space, and prioritize the multiple swap areas according to one or more characteristics of the swap areas to provide a prioritized list of swap areas. Such one or more characteristics of the multiple swap areas may include, for example and not limited to, a respective I/O speed of each swap area of the multiple swap areas, a respective lifetime of each swap area of the multiple swap areas, and a respective cost/price of each swap area of the multiple swap areas. For instance, the prioritized list may be in a descending order of priority such that those swap areas associated with higher I/O speed(s) may be positioned higher in the prioritized list and those swap areas associated with lower I/O speed(s) may be positioned lower in the prioritized list. Logic 415 may revisit and revise this list repeatedly.

For each page in need of swapping, logic 415 may receive an indication or otherwise determine that a given page is in need of swapping. Logic 415 may obtain or otherwise gather one or more indices related to the page and compute or otherwise determine a dynamic threshold based on the one or more indices. That is, logic 415 may receive, obtain or otherwise gather one or more indices of status and/or information for computation of a dynamic threshold associated with each page that needs to be swapped out. For instance, logic 415 may gather one or more indices related to a page in need of swapping including, for example and not limited to, process groups according to the priority definition in the user space, a size of cache and/or free memory in the kernel space, I/O congestion status related to the swap areas, a process class of the process requiring page swap (e.g., whether it is real time), and a size of hardware-used memory (e.g., the status of memory usage associated with GPU and/or multimedia processing unit). Logic 415 may further determine a priority level (e.g., high or low) of the page in need of swapping based on the dynamic threshold.

In some implementations, in implementing algorithm 200, logic 415 may select one of the swap areas from the list of swap areas for the swapping of the page in response to a determination of the priority level of the page. For instance, in an event that it is determined that the priority level of the page is low priority, logic 415 may select one of the swap areas from the prioritized list of swap areas in an ascending order of priority (e.g., from low to high) for the swapping of the page. Otherwise, in an event that it is determined that the priority level of the page is high priority, logic 415 may select one of the swap areas from the prioritized list of swap areas in a descending order of priority (e.g., from high to low) for the swapping of the page.

In some implementations, in implementing algorithm 300, logic 415 may determine whether one or more threshold conditions is/are met. In some implementations, this determination may be done prior to logic 415 determining the priority level of the page in need of swapping. The one or more threshold conditions may include, for example and not limited to, whether the amount of available cache and/or free memory is higher than a predetermined level, whether process group or process priority is higher than another predetermined level, or a combination of the above conditions. In an event of a determination that the one or more threshold conditions is/are met, logic 415 may also determine the availability of one or more swap areas having a highest priority level in the prioritized list of swap areas. In an event of a determination that none of the one or more threshold conditions is met, logic 415 may proceed to determining the priority level of the page in need of swapping. Logic 415 may then select at least one of the one or more swap areas having the highest priority level in the prioritized list of swap areas for the swapping of the page in an event of a determination that the one or more swap areas having the highest priority level is/are available (e.g., not exhausted). In an event of a determination that the one or more swap areas having the highest priority level is/are not available (e.g., exhausted), logic 415 may proceed to determining the priority level of the page in need of swapping.

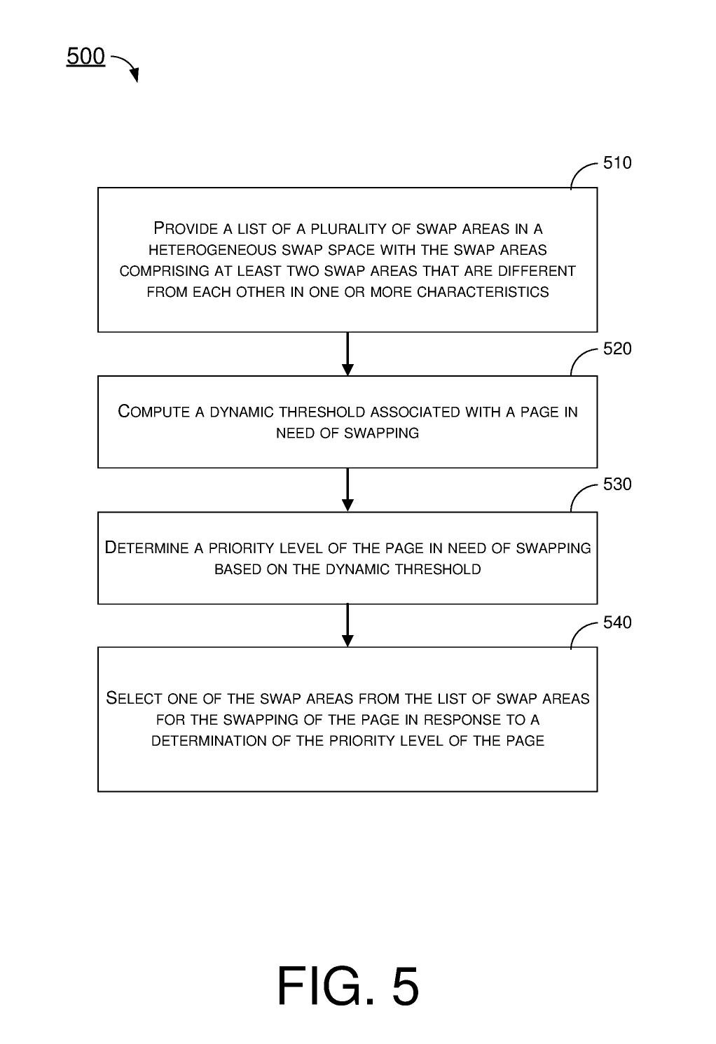

FIG. 5 illustrates an example process 500 in accordance with an implementation of the present disclosure. Process 500 may include one or more operations, actions, or functions as represented by one or more of blocks 510, 520, 530 and 540. Although illustrated as discrete blocks, various blocks of process 500 may be divided into additional blocks, combined into fewer blocks, or eliminated, depending on the desired implementation. The blocks may be performed in the order shown in FIG. 5 or in any other order, depending on the desired implementation. Process 500 may be implemented by apparatus 400 and any variations thereof. For illustrative purposes, description of process 500 below is provided in the context of being performed by apparatus 400. Example process 500 may begin at 510.

At 510, process 500 may involve logic 415 providing a list of a plurality of swap areas in a heterogeneous swap space. The plurality of swap areas may include at least two swap areas that are different from each other in one or more characteristics. Process 500 may proceed from 510 to 520.

At 520, process 500 may involve logic 415 computing a dynamic threshold associated with a page in need of swapping. Process 500 may proceed from 520 to 530.

At 530, process 500 may involve logic 415 determining a priority level of the page in need of swapping based on the dynamic threshold. Process 500 may proceed from 530 to 540.

At 540, process 500 may involve logic 415 selecting one of the swap areas from the list of swap areas for the swapping of the page in response to a determination of the priority level of the page.

In some implementations, in providing the list of the plurality of swap areas, process 500 may involve logic 415 prioritizing the plurality of swap areas based on the one or more characteristics of the plurality of swap areas. In some implementations, the one or more characteristics of the plurality of swap areas may include a respective I/O speed, lifetime and/or cost of each swap area of the plurality of swap areas.

In some implementations, the plurality of swap areas in the heterogeneous swap space may include at least two swap areas that are established on different mediums. In some implementations, the different mediums may include at least two mediums with different I/O speeds.

In some implementations, the plurality of swap areas in the heterogeneous swap space may include at least a first swap area and a second swap area that are established on a same medium. The first swap area may be associated with a first compression algorithm, and the second swap area may be associated with a second compression algorithm different from the first compression algorithm.

In some implementations, in computing the dynamic threshold associated with the page in need of swapping, process 500 may involve logic 415 performing a number of operations. For instance, process 500 may involve logic 415 receiving an indication that the page is in need of swapping. Process 500 may also involve logic 415 obtaining one or more indices related to the page. Process 500 may further involve logic 415 computing the dynamic threshold based on the one or more indices. In some implementations, the one or more indices related to the page may include one or more of the following: cache status, free memory status, I/O status, a process group associated with the page, a process class associated with the page, and hardware memory status.

In some implementations, in selecting the one of the swap areas from the list of swap areas for the swapping of the page, process 500 may involve logic 415 selecting the one of the swap areas from the list of swap areas in an ascending order of priority for the swapping of the page in response to a determination that the priority level of the page is low priority. Alternatively, in selecting the one of the swap areas from the list of swap areas for the swapping of the page, process 500 may involve logic 415 selecting the one of the swap areas from the list of swap areas in a descending order of priority for the swapping of the page in response to a determination that the priority level of the page is high priority.

In some implementations, process 500 may involve logic 415 performing additional operations. For instance, process 500 may involve logic 415 determining whether one or more threshold conditions is/are met. In some implementations, this determination may be done prior to the determining of the priority level of the page in need of swapping. Process 500 may also involve logic 415 determining availability of one or more swap areas having a highest priority level in the prioritized list of swap areas in response to a determination that the one or more threshold conditions is/are met. Process 500 may further involve logic 415 selecting at least one of the one or more swap areas having the highest priority level in the prioritized list of swap areas for the swapping of the page in response to a determination that the one or more swap areas having the highest priority level are available. In some implementations, process 500 may involve logic 415 performing further operations. For instance, process 500 may involve logic 415 proceeding to the determining of the priority level of the page in need of swapping in an event that none of the one or more threshold conditions is met. Process 500 may also involve logic 415 proceeding to the determining of the priority level of the page in need of swapping in response to a determination that the one or more swap areas having the highest priority level are not available.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
providing a list of a plurality of swap areas in a heterogeneous swap space, the swap areas comprising at least two swap areas that are different from each other in one or more characteristics;
computing a dynamic threshold associated with a page in need of swapping;
determining a priority level of the page in need of swapping based on the dynamic threshold; and
selecting one of the swap areas from the list of swap areas for the swapping of the page in response to a determination of the priority level of the page.

2. The method of claim 1, wherein the providing of the list of the plurality of swap areas comprises prioritizing the plurality of swap areas based on the one or more characteristics of the plurality of swap areas.

3. The method of claim 1, wherein the one or more characteristics of the plurality of swap areas comprise a respective input/output (I/O) speed of each swap area of the plurality of swap areas.

4. The method of claim 1, wherein the plurality of swap areas in the heterogeneous swap space comprise at least two swap areas that are established on different mediums.

5. The method of claim 1, wherein the plurality of swap areas in the heterogeneous swap space comprise at least a first swap area and a second swap area that are established on a same medium, wherein the first swap area is associated with a first compression algorithm, and wherein the second swap area is associated with a second compression algorithm different from the first compression algorithm.

6. The method of claim 1, wherein the computing of the dynamic threshold associated with the page in need of swapping comprises:
obtaining one or more indices related to the page; and
computing the dynamic threshold based on the one or more indices.

7. The method of claim 6, wherein the one or more indices related to the page comprises one or more of cache status, free memory status, input/output (I/O) status, a process group associated with the page, a process class associated with the page, and hardware memory status.

8. The method of claim 1, wherein the selecting of the one of the swap areas from the list of swap areas for the swapping of the page comprises selecting the one of the swap areas from the list of swap areas in an ascending order of priority for the swapping of the page in response to a determination that the priority level of the page is low priority.

9. The method of claim 1, wherein the selecting of the one of the swap areas from the list of swap areas for the swapping of the page comprises selecting the one of the swap areas from the list of swap areas in a descending order of priority for the swapping of the page in response to a determination that the priority level of the page is high priority.

10. The method of claim 1, further comprising:
determining whether at least one of one or more threshold conditions is met;
determining availability of one or more swap areas having a highest priority level in the list of swap areas in response to a determination that at least one of the one or more threshold conditions is met; and
selecting at least one of the one or more swap areas having the highest priority level in the list of swap areas for the swapping of the page in response to a determination that the one or more swap areas having the highest priority level are available.

11. The method of claim 10, further comprising:
proceeding to the determining of the priority level of the page in need of swapping in an event that none of the one or more threshold conditions is met; and
proceeding to the determining of the priority level of the page in need of swapping in response to a determination that the one or more swap areas having the highest priority level are not available.

12. An apparatus, comprising:
a heterogeneous swap space comprising a plurality of swap areas, the plurality of swap areas comprising at least two swap areas that are different from each other in one or more characteristics; and
a processor configured to perform operations comprising:
providing a list of the plurality of swap areas in the heterogeneous swap space;
computing a dynamic threshold associated with a page in need of swapping;
determining a priority level of the page in need of swapping based on the dynamic threshold; and
selecting one of the swap areas from the list of swap areas for the swapping of the page in response to a determination of the priority level of the page.

13. The apparatus of claim 12, wherein, in providing the list of the plurality of swap areas, the processor is configured to prioritize the plurality of swap areas based on the one or more characteristics of the plurality of swap areas.

14. The apparatus of claim 12, wherein the one or more characteristics of the plurality of swap areas comprise a respective input/output (I/O) speed of each swap area of the plurality of swap areas.

15. The apparatus of claim 12, wherein the plurality of swap areas in the heterogeneous swap space comprise at least two swap areas that are established on different mediums.

16. The apparatus of claim 12, wherein the plurality of swap areas in the heterogeneous swap space comprise at least a first swap area and a second swap area that are established on a same medium, wherein the first swap area is associated with a first compression algorithm, and wherein the second swap area is associated with a second compression algorithm different from the first compression algorithm.

17. The apparatus of claim 12, wherein, in computing the dynamic threshold associated with the page in need of swapping, the processor is configured to perform operations comprising:
obtaining one or more indices related to the page; and
computing the dynamic threshold based on the one or more indices.

18. The apparatus of claim 17, wherein the one or more indices related to the page comprises one or more of cache status, free memory status, input/output (I/O) status, a process group associated with the page, a process class associated with the page, and hardware memory status.

19. The apparatus of claim 12, wherein, in selecting the one of the swap areas from the list of swap areas for the swapping of the page, the processor is configured to select the one of the swap areas from the list of swap areas in an ascending order of priority for the swapping of the page in response to a determination that the priority level of the page is low priority.

20. The apparatus of claim 12, wherein, in selecting the one of the swap areas from the list of swap areas for the swapping of the page, the processor is configured to select the one of the swap areas from the list of swap areas in a descending order of priority for the swapping of the page in response to a determination that the priority level of the page is high priority.

21. The apparatus of claim 12, wherein the process is further configured to perform operations comprising:
determining whether at least one of one or more threshold conditions is met;
determining availability of one or more swap areas having a highest priority level in the list of swap areas in response to a determination that at least one of the one or more threshold conditions is met; and
selecting at least one of the one or more swap areas having the highest priority level in the list of swap areas for the swapping of the page in response to a determination that the one or more swap areas having the highest priority level are available.

22. The apparatus of claim 21, wherein the process is further configured to perform operations comprising:
proceeding to the determining of the priority level of the page in need of swapping in an event that none of the one or more threshold conditions is met; and
proceeding to the determining of the priority level of the page in need of swapping in response to a determination that the one or more swap areas having the highest priority level are not available.
